(19) United States
(12) Patent Application Publication
(10) Pub. No.: US 2009/0083145 A1
(43) Pub. Date: Mar. 26, 2009

(54) DYNAMIC HOSTED ADVERTISING SUPPORTING MULTIPLE FORMATS

(75) Inventor: Tze Meng Lee, Mountain View, CA (US)

Correspondence Address: SENNIGER POWERS LLP (MSFT), 100 NORTH BROADWAY, 17TH FLOOR, ST. LOUIS, MO, 63102, US

(73) Assignee: MICROSOFT CORPORATION, Redmond, WA (US)

(21) Appl. No.: 11/861,992

(22) Filed: Sep. 26, 2007

(51) Int. Cl. G06Q 30/00

(52) U.S. Cl. 705/14

(57) ABSTRACT

Defining an advertisement component to have a plurality of advertising systems each supporting a different advertising format. For example, the formats include rich media advertisements, still images, audio, and video. The defined advertisement component is sent to a computing device for execution. Data identifying a particular advertising system is also sent to the computing device. The computing device configures the advertisement component to select the advertising system identified by the data. The selected advertising system receives and display advertisements in the corresponding format.

### BACKGROUND

Electronic advertisements such as those seen on web pages are served from one computer to another. The advertisements include images, text, audio, and/or video. Advertisements also differ in terms of user interaction and required bandwidth. Some applications only support simple advertisements such as text and still images. Other applications support more advanced media technologies using scripts or plug-ins. These advanced media technologies are referred to as rich media advertisements (RMA). Many existing systems, however, do not support more than one type of media technology. In addition, some of the advanced media technologies are unstable. Attempts to display such advertisements may result in the advertisements not being displayed, or instability or even failure of the application attempting to display the advertisements.

### SUMMARY

Embodiments of the invention enable configuration of an advertisement component to display advertisements in a particular format. The advertisement component has a plurality of advertising systems each corresponding to at least one advertisement format. In an embodiment, the invention sends one or more values to a computing device to identify one of the advertising systems for execution by the computing device. The identified advertising system receives and displays advertisements to the user in the advertising format associated with the identified advertising system.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary block diagram illustrating the components associated with a first computing device communicating with a second computing device.

FIG. 2 is an exemplary block diagram illustrating delivery of an advertisement component to a client during a login process.

FIG. 3 is an exemplary block diagram illustrating configuration of the advertisement component and delivery of advertisements to a client.

FIG. 4 is an exemplary flow chart illustrating selection of an advertisement component and delivery of advertisements to the selected advertisement component.

FIG. 5 is an exemplary flow chart illustrating configuration of an advertisement component using two values.

Corresponding reference characters indicate corresponding parts throughout the drawings.

### DETAILED DESCRIPTION

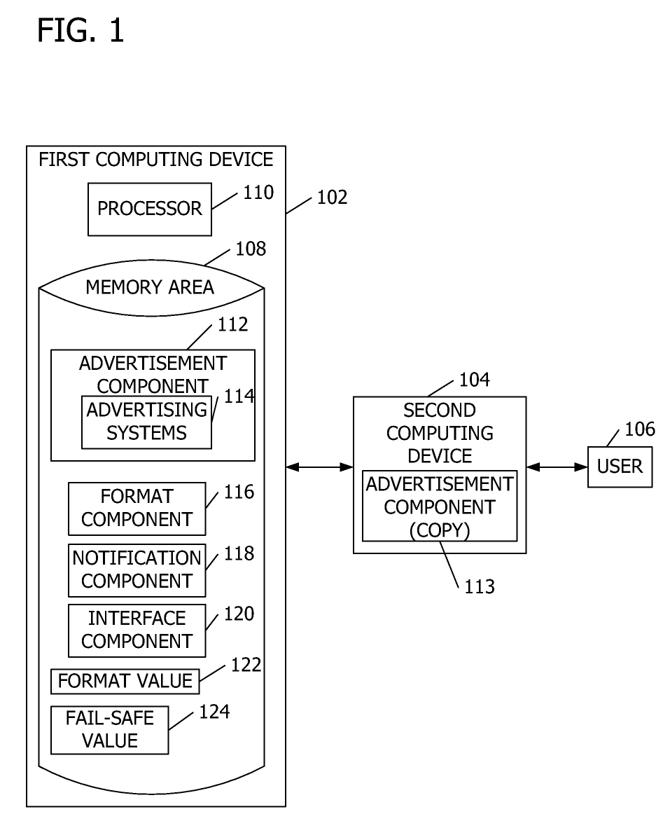

In an embodiment, the invention includes a configurable advertisement component 112 supporting a plurality of advertising formats such as shown in FIG. 1. In particular, the invention enables seamless switching between the advertisement formats to support different types of advertisements. For example, the types of advertisements include still images, video, audio, interactive data, and/or non-interactive data. In this manner, a variety of advertisement content is provided to a user 106 while any applications associated with the advertisement display are protected.

Referring first to FIG. 1, an exemplary block diagram illustrates the components associated with a first computing device 102 communicating with a second computing device 104. The user 106 accesses the second computing device 104 to, for example, execute one or more applications. The first computing device 102 includes a memory area 108 and a processor 110. The memory area 108 is accessible by the first computing device 102 locally or remotely (not shown). The memory area 108 stores the advertisement component 112 having a plurality of advertising systems 114 each corresponding to at least one of a plurality of advertisement formats. The second computing device 104 stores a copy of the advertisement component 113. For example, the copy 113 is a copy cached or hosted by a web browser or client executing on the second computing device 104. In this example, the first computing device 102 includes a mail server. In an embodiment, the invention is implemented using web development technologies such as asynchronous JAVASCRIPT and extensible markup language (XML) technologies.

At least one of the plurality of advertisement formats corresponds to rich media advertisements (RMAs). RMAs include advertisements created with media technologies that offer higher quality advertisements. For example, RMAs include, but are not limited to, advertisements with one or more of the following characteristics: created with JAVASCRIPT, use flash video, expand or exceed the intended original border of the advertisement, allow user interaction with the advertisement, include animation, and include sound. Non-RMAs include advertisements that display, for example, still images or text. In am embodiment, non-RMAs use inline frames or other basic framing technology (e.g., for use in a browser).

In operation, the processor 110 is configured to execute computer-executable instructions or components to implement aspects of the invention. For example, the processor 110 may execute one or more computer-executable components stored on one or more computer-readable media. In the example of FIG. 1, the memory area 108 stores a format component 116, the advertisement component 112, a notification component 118, and an interface component 120.

The format component 116 defines a plurality of advertisement formats. The advertisement component 112 displays advertisements to the user 106 using one or more of the advertising systems 114. The notification component 118 receives, by the first computing device 102, a notification from the second computing device 104 that the second computing device 104 is executing an application. For example, the user 106 selects a mail application for execution. The interface component 120 transmits, responsive to the received notification, the advertisement component 112 associated with the application from the first computing device 102 to the second computing device 104. The second computing device 104 stores the transmitted copy of the advertisement component 112. For example, the copy is cached by the second computing device 104. Caching the advertisement component 112 on the second computing device 104 improves performance. For example, there is less reliance on network communications by a cached advertisement component 113.

In an embodiment (not shown), a plurality of advertisement components 112 exist. Each advertisement component 112 is associated with one or more applications. For example, there is an advertisement component associated with a mail program, an advertisement component associated with a chat program, an advertisement component associated with a blog program, and the like. The appropriate advertisement component is selected and transmitted to the second computing device 104 responsive to the notification received from the second computing device 104. The advertisement component may be operable within the associated application, or may execute separately and be distinct from the associated application.

The interface component 120 also sends session data indicating, for example, which of the advertising systems 114 should be used to receive and display advertisements in association with the user-selected application (e.g., the mail application). In an embodiment, the session data includes a value that corresponds to one of the available advertising systems 114. For example, the value is associated with a session-based configuration variable. Various factors dictate which advertising system 114 should be used by the second computing device 104. The value is determined by a human operator based on business or marketing decisions in an embodiment. In another embodiment, the value is chosen based on the advertisement provider. The value may be determined and applied to all computing device acting as second computing devices. In another example, the value may be determined on a per user, per device, per advertisement, or per advertisement provider basis. The second computing device 104 relies on the value, and does not alter the value in an embodiment. In this manner, all devices such as the second computing device 104 that receive the value will execute the advertising system 114 identified by the value. In an embodiment, the value is session-based in that the value does not change during a session. In other embodiments, the first computing device 102 may change the value at any time.

In another embodiment, the session data includes a fail-safe value 124 and a format value 122. These values collectively identify one of the advertising systems 114 for execution by the second computing device 104. Responsive to receiving the fail-safe value 124 and the format value 122, the second computing device 104 dynamically configures the copy of the advertisement component 112 as a function of the transmitted fail-safe value 124 and the format value 122 to receive and display advertisements by the advertising system 114 identified by the fail-safe value 124 and the format value 122. As a result, the advertisements are received and subsequently displayed in the advertising format corresponding to the identified advertising system.

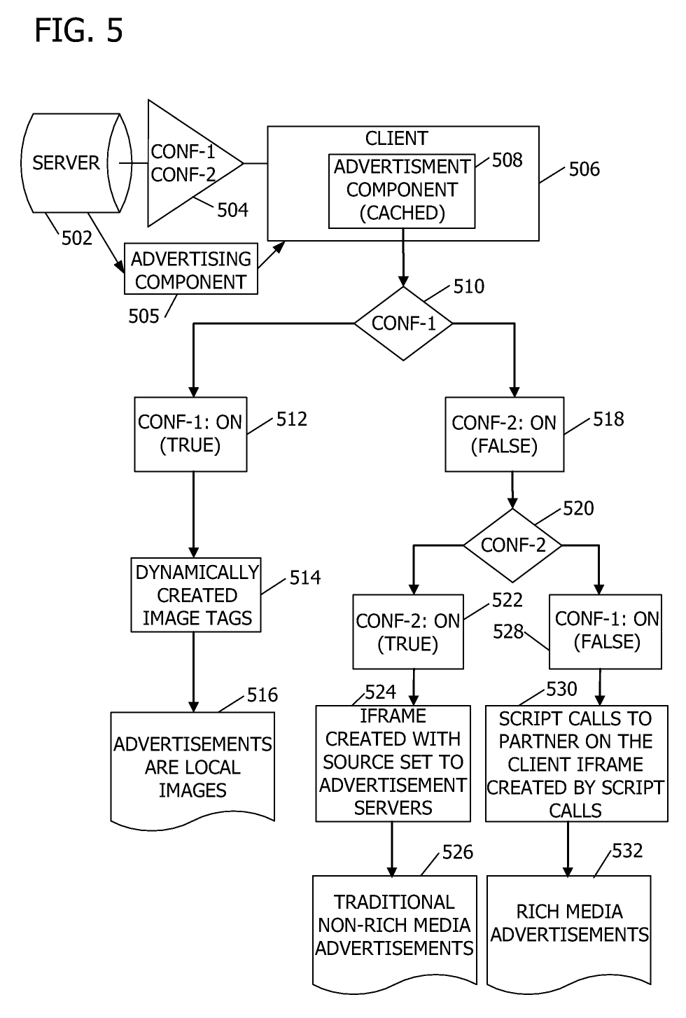

In an embodiment, the fail-safe value 124 overrides, or takes priority over, the format value 122 as described in greater detail with reference to FIG. 5. The fail-safe value 124 allows the closure of all other advertising systems 114 in the advertisement component 112 to protect the application associated with the advertisement component 112. For example, should one or more of the advertising systems 114 fail, the second computing device 104 switches to an advertising system 114 that displays information in a simple, basic format (e.g., text, still images, etc.). This functionality protects the applications executing on the second computing device 104 and enables those applications to execute independent of the advertising system 114 executing on the second computing device 104.

The session data may include any means or methodology for identifying one of the advertising systems 114 available in the advertisement component 112. For example, the session data may include one or more values such as Boolean values (e.g., TRUE or FALSE), integers, alphabetic characters, or the like for identifying one of the advertising systems 114. For example, if the fail-safe value 124 is TRUE, the advertisement component 112 executes on the second computing device 104 to display static images. The static images may be delivered from the first computing device 102 to the second computing device 104, or may be stored locally on the second computing device 104 (e.g., in a library, pool, or repository of available advertisements). In another example, rich media advertisements may be displayed when the fail-safe value 124 is FALSE and the format value 122 evaluates to FALSE. In this example, the advertisements are served by an advertisement provider that is remote from the second computing device 104, but in communication with software executing on the second computing device 104.

After configuration of the advertisement component 112, the second computing device 104 executes the selected or identified advertising system. Responsive to user interaction with the application (e.g., the mail program), advertisements are delivered to the selected advertising system 114 for display or rendering to the user 106. For example, by checking for new electronic mail messages or by sending an email, the user 106 creates user action data that is received by the second computing device 104. In an embodiment, the second computing device 104 communicates the user action data to the first computing device 102. In response to the received user action data, the first computing device 102 transmits, or causes to transmit, the advertisements to the user 106 (e.g., depending on the particular advertising system 114 executing on the second computing device 104). For example, the first computing device 102 sends the advertisements to the second computing device 104 for display, by the second computing device 104, to the user 106.

In another embodiment, the second computing device 104 does not transmit the user action data to the first computing device 102. Rather, the second computing device 104 uses the user action data to select an advertisement from a library of static advertisements available to the second computing device 104 for selection and rendering.

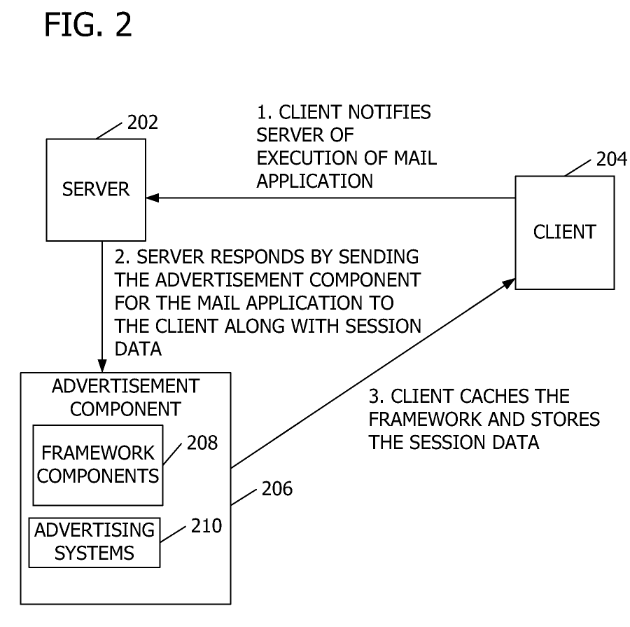

Referring next to FIG. 2, an exemplary block diagram illustrates delivery of an advertisement component 206 by a server 202 to a client 204 during a login process. In an embodiment (not shown), the server 202 and client 204 communicate via a network. The client 204 notifies the server 202 of execution of an application such as a mail application on the client 204. For example, this may occur during login by a user accessing the client 204. In response, the server 202 sends the advertisement component 206 or framework for the mail application to the client 204 along with session data. The advertisement component 206 includes framework components 208 and advertising systems 210. For example, the advertising systems 210 rely on logic from the framework components 208 to perform various functions such as network communications or the like. The client 204 caches the advertisement component 206.

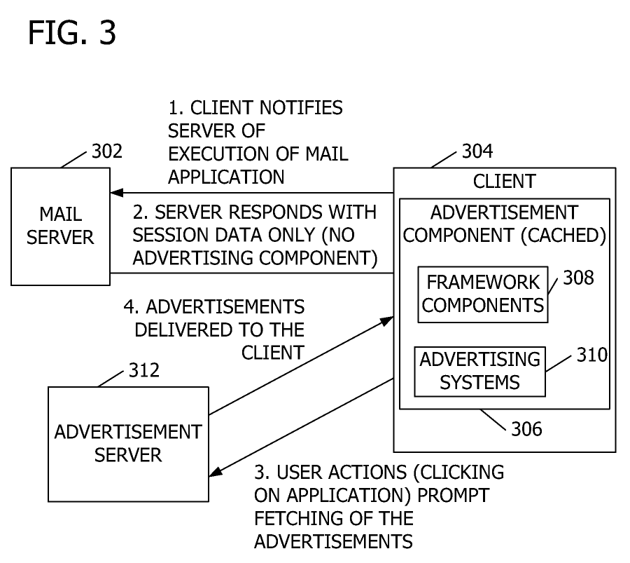

Referring next to FIG. 3, an exemplary block diagram illustrates configuration of a cached advertisement component 306 and delivery of advertisements by a mail server 302 to a client 304. The client 304 stores a copy of the advertisement component 306 (e.g., a cached copy) including framework components 308 and advertising systems 310 delivered previously such as in FIG. 2. The client 304 notifies the server 302 of execution of an application such as a mail application on the client 304. For example, this may occur during a subsequent login by a user accessing the client 304. In response, the server 302 sends session data. The client 304 uses the session data to configure the cached advertisement component 306 to use one of the advertising systems 310 to receive and display advertisements. There is no need to re-send the advertisement component 306 because that component was sent previously (e.g., see FIG. 2). The user proceeds to interact with the mail application on the client 304. Actions of the user (e.g., checking for new mail, composing a mail message, deleting a message, etc.) prompt the mail application to use the cached advertisement component 306 to fetch and display advertisements. The advertisements are delivered from, for example, an advertisement server 312 or provider to the client 304.

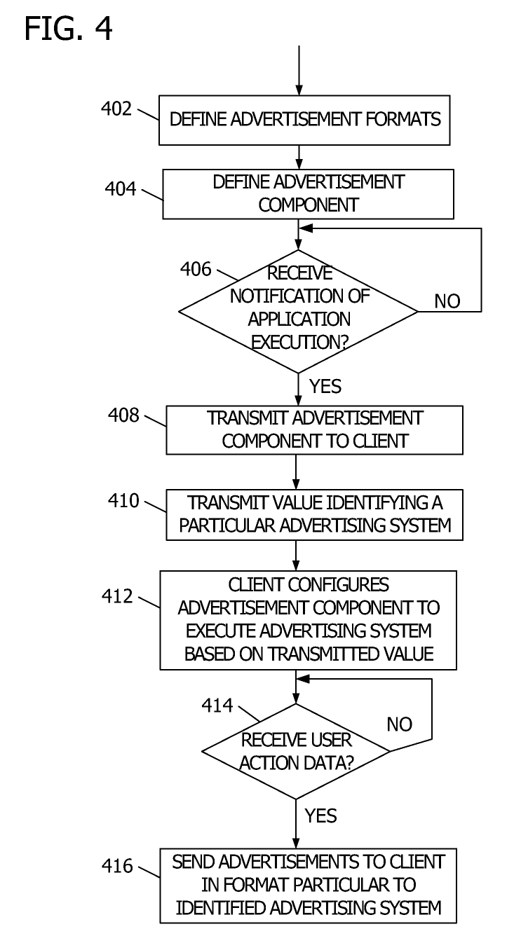

Referring next to FIG. 4, an exemplary flow chart illustrates selection of an advertisement component and delivery of advertisements to the selected advertisement component. The flow chart in FIG. 4 illustrates generally the operations performed by a computing device such as server 202 in FIG. 2 or mail server 302 in FIG. 3. At 402, one or more advertisement formats are defined. For example, the formats include rich media advertisements delivered from advertisement suppliers remote from the second computing device, non-rich media advertisements from a data store local to the second computing device, static local advertisements from a data store local to the second computing device, or other formats and advertisement sources.

An advertisement component is defined at 404 to have one or more advertising systems. Each of the advertising systems corresponds to at least one of the defined advertisement formats. If the server computing device receives notification of application execution at 406, the server computing device transmits the defined advertisement component to another computing device such as a client at 408. In an embodiment, the server computing device may add new advertising systems dynamically and update all client computing devices in this manner rather than sending a patch or other fix to the application executing on the client computing devices.

The server computing device also transmits session data at 410 including a value identifying a particular adverting system to be used by the client computing device. The client computing device configures the received advertisement component at 412 to execute or otherwise use the advertising system identified by the transmitted value.

When user action data is received by the client computing device at 414 (e.g., any interaction between the user and the application), the client computing device (or the advertisement component executing thereon) notifies the server computing device or an advertisement provider. In response, the server computing device or advertisement provider sends at 416 selected advertisements to the client computing device in the format corresponding to the identified advertising system.

In an embodiment (not shown), the server computing device transmits another value client computing device to select a different advertising system for the advertisement component on the client computing device to use. In response, the client computing device re-configures the advertisement component as a function of this new value to receive and display advertisements by the different advertising system. Subsequent user interactions with the application on the client computing device prompt the advertisement component to receive and display advertisements in the format corresponding to the newly selected advertising system.

Referring next to FIG. 5, an exemplary flow chart illustrates configuration of an advertisement component using two values. A server 502 sends values for configuration variables conf-1 and conf-2 at 504 to a client 506. If the client 506 does not already have a cached copy of an advertisement component 508, the server 502 sends the advertisement component 505 to the client 506 for caching. Conf-1 is evaluated at 510. Conf-1 determines whether to disable the advanced advertising systems and instead use a system that serves in-house images. If conf-1 evaluates to TRUE at 512, the advertisement component 508 selects an advertising system that uses dynamically created image tags at 514 and local images as the advertisements at 516. For example, all advertisement tags are cleared and in-house image tags are inserted into web page data displayed to the user. If conf-1 evaluates to FALSE at 518, conf-2 is evaluated at 520. If conf-2 evaluates to TRUE at 522, the advertisement component 508 selects an advertising system that uses inline frames displaying advertisements delivered from advertisement servers at 524. For example, uniform resource locators are inserted into the inline frames to reference the advertisement servers. This results in the display of traditional, non-rich media advertisements at 526.

If conf-2 evaluates to FALSE at 528, the advertisement component uses script calls provided by the advertisement servers to create inline frames at 530. The script calls trigger rich media advertisements at 532. For example, this functionality is performed by partner application programming logic calls in JAVASCRIPT.

### Exemplary Operating Environment

A general purpose computing device such as a computer has one or more processors or processing units and a system memory. The computer typically has at least some form of computer readable media. Computer readable media, which include both volatile and nonvolatile media, removable and non-removable media, may be any available medium that may be accessed by computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The computer may operate in a networked environment using logical connections to one or more remote computers, such as a remote computer.

Generally, the data processors of computer are programmed by means of instructions stored at different times in the various computer-readable storage media of the computer. Aspects of the invention described herein includes these computer-readable storage media when such media contain instructions or programs for implementing the operations described herein in conjunction with a microprocessor or other data processor. Further, aspects of the invention include the computer itself when programmed according to the methods and techniques described herein.

Embodiments of the invention are operational with numerous general purpose or special purpose computing system environments or configurations. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The computer-executable instructions and components described and illustrated herein constitute exemplary means for configuring the copy of the advertisement component as a function of the value to use the advertising system identified by the value to receive and display the advertisements to the user. In addition, the computer-executable instructions and components described and illustrated herein constitute exemplary means for associating the value with one of the advertising systems in the advertisement component.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method comprising:
defining a plurality of advertisement formats;
defining a plurality of advertisement components each having a plurality of advertising systems associated therewith, each of the plurality of advertising systems corresponding to at least one of the defined advertisement formats;
receiving, by a first computing device, a notification from a second computing device that the second computing device is executing an application;
responsive to the received notification, selecting one of the plurality of advertisement components based on the application executing on the second computing device;
transmitting the selected advertisement component associated with the application from the first computing device to the second computing device; and
transmitting a value from the first computing device to the second computing device, said value identifying one of the advertising systems for execution by the second computing device, wherein the second computing device configures the transmitted advertisement component as a function of the value to receive and display advertisements by the advertising system identified by the value, said advertisements being displayed in the advertising format corresponding to the identified advertising system.

2. The method of claim 1, wherein the plurality of advertisement formats comprises rich media advertisements delivered from advertisement suppliers remote from the second computing device, non-rich media advertisements from a data store remote to the second computing device, and static local advertisements from a data store local to the second computing device.

3. The method of claim 1, further comprising:
receiving user action data from the second computing device, said user action data corresponding to an interaction between a user and the application; and
responsive to the received user action data, sending the advertisements to the second computing device.

4. The method of claim 1, further comprising:
transmitting another value from the first computing device to the second computing device, said other value identifying another one of the advertising systems for execution by the second computing device, wherein the second computing device configures the advertisement component as a function of the other value to receive and display advertisements by the other one of the advertising systems identified by the other value, said advertisements being displayed in the advertising format corresponding to the identified, other advertising system.

5. The method of claim 1, further comprising determining the value as a function of a user associated with the second computing device.

6. The method of claim 1, further comprising determining the value as a function of the second computing device.

7. The method of claim 1, further comprising determining the value as a function of the advertisements.

8. The method of claim 1, wherein the second computing device receives the advertisements from an advertisement provider.

9. The method of claim 1, wherein the second computing device executes an electronic mail application within a web browser.

10. One or more computer-readable media having computer-executable components, said components comprising:
a format component for defining a plurality of advertisement formats;
an advertisement component for displaying advertisements to a user, said advertisement component having at least three advertising systems each corresponding to at least one of the advertisement formats defined by the format component;
a notification component for receiving, by a first computing device, a notification from a second computing device that the second computing device is executing an application; and
an interface component for transmitting, responsive to the received notification, the advertisement component from the first computing device to the second computing device, said interface component further transmitting a fail-safe value and a format value from the first computing device to the second computing device, said fail-safe value and said format value collectively identifying one of the advertising systems for execution by the second computing device, wherein the second computing device configures the transmitted advertisement component as a function of the transmitted fail-safe value and the format value to receive and display advertisements by the advertising system identified by the fail-safe value and the format value, said advertisements being displayed in the advertising format corresponding to the identified advertising system, wherein the fail-safe value overrides the format value when identifying the advertising system.

11. The computer-readable media of claim 10, wherein the fail-safe value and the format value collectively identifying one of the advertising systems for execution by the second computing device.

12. The computer-readable media of claim 10, wherein the fail-safe value and the format value each comprise one of TRUE or FALSE.

13. The computer-readable media of claim 12, wherein the transmitted advertisement component executes on the second computing device to display static images when the fail-safe value is TRUE, said static images being delivered from the first computing device.

14. The computer-readable media of claim 12, wherein the transmitted advertisement component executes on the second computing device to display rich media advertisements when the fail-safe value is FALSE and the format value is FALSE, said rich media advertisements being delivered from an advertisement provider.

15. A system comprising:
a memory area associated with a first computing device, said memory area storing an advertisement component having a plurality of advertising systems each corresponding to at least one of a plurality of advertisement formats, wherein a second computing device stores a copy of the advertisement component including the plurality of advertising systems; and
a processor in the first computing device, said processor configured to execute computer-executable instructions for:
receiving, by a first computing device, a notification from a second computing device that the second computing device is executing an application;
transmitting, responsive to the received notification, a value from the first computing device to the second computing device, said value identifying one of the advertising systems for execution by the second computing device, said value being associated with the application executing on the second computing device, wherein the second computing device configures the copy of the advertisement component as a function of the value to use the advertising system identified by the value to receive and display advertisements to a user;
receiving user action data from the second computing device, said user action data corresponding to an interaction between the user and the application; and
responsive to the received user action data, transmitting the advertisements to the identified advertising system on the second computing device.

16. The system of claim 15, further comprising means for configuring the copy of the advertisement component as a function of the value to use the advertising system identified by the value to receive and display the advertisements to the user.

17. The system of claim 15, further comprising means for associating the value with one of the advertising systems in the advertisement component.

18. The system of claim 15, wherein the copy of the advertisement component is cached by the second computing device.

19. The system of claim 15, wherein the first computing device comprises a mail server and the second computing device comprises a client executing a web browser.

20. The system of claim 15, wherein at least one of the plurality of advertisement formats comprises corresponds to rich media advertisements.
